(19) United States
(12) Patent Application Publication
(10) Pub. No.: US 2009/0160779 A1
(43) Pub. Date: Jun. 25, 2009

(54) Emulating A Keyboard On A Touch Screen Monitor Of A Computer System

(75) Inventors: Timothy W. Crockett, Raleigh, NC (US); Charles R. Kirk, Raleigh, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/960,559

(22) Filed: Dec. 19, 2007

(51) Int. Cl. G06F 3/041

(52) U.S. Cl. 345/173

(57) ABSTRACT

Methods, apparatus, and products for emulating a keyboard on a touch screen monitor of a computer system are described that include displaying on the touch screen monitor through an on-screen display (‘OSD’) module of the touch screen monitor a merged image comprising a graphics display image from a video adapter of the computer system and a keyboard image; receiving, by a touch screen module, an input on the merged image displayed on the touch screen monitor; determining, by the touch screen module, whether the input is a keyboard keystroke; if the input is a keyboard keystroke: converting, by the touch screen module, the input to a keyboard keystroke in a native keyboard format; and sending, by the touch screen module, the converted keyboard keystroke in the native keyboard format to a keyboard input adapter of the computer system.

### BACKGROUND OF THE INVENTION

1. Field of the Invention

The field of the invention is data processing, or, more specifically, methods, apparatus, and products for emulating a keyboard on a touch screen monitor of a computer system.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computer systems today are often used in many different environments. Computer systems may be used for personal use at a user's home, for business use as a workstation at a user's desk, in manufacturing environments, and in retail stores. Such computer systems may include touch screen monitors. Computer systems having touch screen monitors often require no other user input device connected to the computer system for typical operation. In some cases, however, rarely used applications or recovery from a computer system malfunction requires a keyboard or other input device. In these situations, this can be costly in terms of time spent on connecting such input devices as well as in terms of the cost of such device. Current methods of emulating input devices use specialized software on the system and do not provide emulation of the input devices through a touch screen monitor in such a way that the computer system appears to be connected to the actual input device. Specifically, current keyboard emulation techniques do not provide emulating a keyboard, such as Universal Serial Bus (USB) keyboard, through a touch screen monitor interface, such that a computer system appears to be connected to an actual USB keyboard.

### SUMMARY OF THE INVENTION

Methods, apparatus, and products for emulating a keyboard on a touch screen monitor of a computer system are described that include displaying on the touch screen monitor through an on-screen display (‘OSD’) module of the touch screen monitor a merged image comprising a graphics display image from a video adapter of the computer system and a keyboard image; receiving, by a touch screen module, an input on the merged image displayed on the touch screen monitor; determining, by the touch screen module, whether the input is a keyboard keystroke; if the input is a keyboard keystroke: converting, by the touch screen module, the input to a keyboard keystroke in a native keyboard format; and sending, by the touch screen module, the converted keyboard keystroke in the native keyboard format to a keyboard input adapter of the computer system.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary computer system for emulating a keyboard on a touch screen monitor of the computer system according to embodiments of the present invention.

FIG. 2 sets forth a line drawing illustrating an exemplary touch screen monitor of a computer system useful in emulating a keyboard according to embodiments of the present invention.

FIG. 3 sets forth a flow chart illustrating an exemplary method for emulating a keyboard on a touch screen monitor of a computer system according to embodiments of the present invention.

### DETAILED DESCRIPTION OF EXEMPLARY EMBODIMENTS

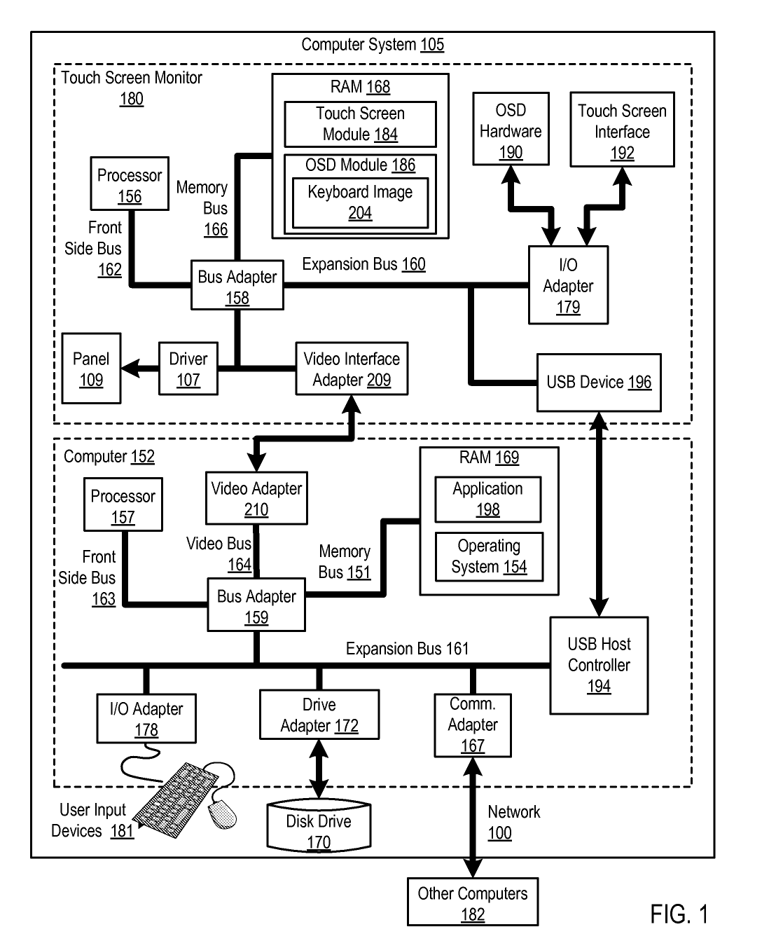

Exemplary methods, apparatus, and products for emulating a keyboard on a touch screen monitor of a computer system in accordance with the present invention are described with reference to the accompanying drawings, beginning with FIG. 1. FIG. 1 sets forth a block diagram of an exemplary computer system (105) for emulating a keyboard on a touch screen monitor (180) of the computer system (105) according to embodiments of the present invention. The exemplary computer system of FIG. 1 includes several computing devices, that is, automated computing machinery. Such computing devices include, for example, a touch screen monitor (180) and a computer (152).

A touch screen monitor is a computer monitor having an overlay which is capable of receiving user input. Such an overlay connects to a touch screen interface in the touch screen monitor for processing user input. Touch screens may implemented with overlays according to a number of different technologies including, for example, resistive technology, Surface Acoustic Wave (‘SAW’) technology, capacitive technology, Infrared (‘IR’) technology, strain gauge technology, optical imaging technology, dispersive signal technology, acoustic pulse recognition technology, frustrated total internal reflection technology, and other technologies as will occur to those of skill in the art. Each of the overlays technologies, upon receiving a touch input, provides an electrical signal, through a touch screen interface, to a touch screen module (194) for processing the input. The electrical signal is used in identifying a coordinate associated with the location on the overlay where the touch input originated. Consider as just one example touch screen having an overlay, a resistive touch screen. A resistive touch screen overlay includes a conductive and a resistive metallic layer. These two layers are held apart by spacers. An electrical current runs through the two layers. When a user touches the screen, the two layers make contact. The contact causes a change in the electrical field which is registered as an input by the touch screen interface.

In addition to receiving input through an overlay and a touch screen interface (192), touch screen monitors also display images. The touch screen monitor (180) of FIG. 1 therefore includes a video interface adapter (209) that receives and processes graphics display images from the video adapter (210) of the exemplary computer (152) of FIG. 1. Video interface adapters may provide many functions include analog to digital conversion, synchronization of video input, video format conversion, and other video processing as will occur to those of skill in the art. Graphics display images, after being processed by the video input adapter, are typically displayed on a panel (109) through use of a driver (107). A panel may be implemented as a flat panel display such as, for example, a liquid crystal display (‘LCD’) or a thin-film transistor LCD. In addition to various types of LCDs, the touch screen monitor may also be implemented with other displays including for example:
A cathode ray tube (‘CRT’) display;
A plasma display;
Texas Instrument's™ Digital Light Processing (‘DLP’) display;
An Organic Light-Emitting Diode Display (‘OLED’);
A Surface-Conduction Electron-Emitter Display (‘SED’);
A Field Emission Display (‘FED’);
Or any other display technology as will occur to those of skill in the art.

Both the touch screen monitor (180) and the computer (152) of FIG. 1 include at least one computer processor (156,157) or ‘CPU’ as well as random access memory (168,169) (‘RAM’) which is connected through a high speed memory bus (166,151) and bus adapter (158,159) to the processor (156,157) and to other components. Readers of skill in the art will recognize that in addition to or instead of the touch screen monitor (180) including RAM, the touch screen monitor may in fact include some form of non-volatile memory such as ROM or EEPROM.

Stored in RAM (168) of the exemplary touch screen monitor (180) of FIG. 1 is a touch screen module (184), a module of computer program instructions for processing input on the touch screen monitor, identifying a coordinate associated with the input, and transmitting the coordinate to the computer (152). Alternatively, the touch screen module (184) may process the input and transmit the input directly to the computer on which a device driver for the touch screen monitor processes the input and identifies a coordinate. The touch screen module (184) may be implemented as a standalone software application running in the touch screen monitor or firmware as will occur to those of skill in the art.

Also stored in RAM (168) of the exemplary touch screen monitor (180) of FIG. 1 is an on-screen display (‘OSD’) module (186), a module of computer program instructions for emulating a keyboard on the touch screen monitor (180) of the computer system (105). The on-screen display module (186) operates generally for emulating a keyboard on the touch screen monitor (180) of the computer system (105) by displaying on the touch screen monitor (180) a merged image (188) that includes a graphics display image from a video adapter (210) of the computer system (152) and a keyboard image (204).

The on-screen display module is also capable of receiving, by the OSD module of the touch screen monitor, a keyboard activation event and, responsive to the keyboard activation event, merging a graphics display image from the video adapter of the computer system and a keyboard image. A keyboard activation event is an event that causes the on-screen display module of he touch screen monitor to merge, for display on the monitor, an image of a keyboard with a graphics display image from the video adapter of a computer. Receiving a keyboard activation event may include receiving a keyboard activation event in response to an invocation of a dedicated hardware switch of the touch screen monitor. OSD hardware (190) may include one or more hardware switches, such as buttons, installed in the touch screen monitor. Typical monitors may include several hardware switches that activate different OSD functions. Some monitors, for example, include a menu button, a plus button, and minus button. Invoking the menu button causes the OSD module to display a menu for various touch screen control option. The plus and minus buttons allow a user to navigate the menu of touch screen controls options and select an option. A hardware switch for invoking a keyboard activation event may be a button, similar to other OSD buttons, but dedicated only for the purpose of invoking a keyboard activation event. As an alternative receiving a keyboard activation event in response to an invocation of a dedicated hardware switch, receiving a keyboard activation event my include receiving the activation event in response to invocation of an object, such as a button, of a graphical user interface presented by the on-screen display module. The invocation of the GUI object may include a user touching the touch screen at the location of the GUI object on the screen or by the user selecting the object through use of hardware of the touch screen dedicated for such purpose.

Typical on-screen display modules merge an image, stored in memory on the monitor, with a graphics display image received from a connected host computer. The image stored in memory is typically a menu for control of various display parameters of the monitor such as contrast, brightness, vertical and horizontal stretch, image skew, and others as will occur to those of skill in the art. The image of the menu is typically displayed, as part of the merged image, as an overlay on top of the original graphics display image from the connected host computer. The OSD module of FIG. 1 is improved in that instead of merging a typical menu for control of display parameters of the monitor, the OSD module of FIG. 1 may merge a keyboard image (204) with the graphics display image from the video adapter (210) of the computer (152). The images may be merged by a multiplexer in the video interface adapter (209) and then displayed on the panel (109) through the driver (107).

The touch screen module (184) stored in RAM (168) of the touch screen monitor (180) of FIG. 1 also operates for emulating a keyboard on a touch screen monitor of a computer system according to embodiments of the present invention. The touch screen module (184) includes computer program instructions capable of receiving an input on the merged image displayed on the touch screen monitor; determining whether the input is a keyboard keystroke; if the input is a keyboard keystroke, converting the input to a keyboard keystroke in a native keyboard format and sending the converted keyboard keystroke in the native keyboard format to a keyboard input adapter of the computer system.

As mentioned above, the touch screen monitor may include one of many types of overlays connected to the touch screen interface. Receiving an input on the merged image displayed on the touch screen monitor may be carried out by identifying an input through the touch screen overlay connected to the touch screen interface (192) of the touch screen monitor. Receiving an input on a touch screen monitor having a resistive overlay, for example, may be carried out by identifying a change in the electrical current that runs through the two layers of the resistive overlay.

A ‘keyboard keystroke’ as used in the specification represents the pressing of a key on a keyboard. The term ‘native keyboard format’ as used in the specification refers to a format of data transmitted from typical hardware keyboards, such as a Universal Serial Bus (‘USB’) or PS/2 keyboard, to a computer. A keyboard keystroke in a native keyboard format may be, for example, a PS/2 scan code or a USB usage code for devices of the USB device class for human interface devices (‘HID’). The ‘native keyboard format’ is distinct from the format of data typically transmitted from the touch screen monitor to the computer. As mentioned above, the touch screen monitor typically transmits coordinates to a computer system through a USB device (196).

The touch screen module (184) of FIG. 1 may send the converted keyboard keystroke in the native keyboard format to a keyboard input adapter of the computer system in various ways as will occur to those of skill in the art. A keyboard input adapter may be implemented as any I/O adapter capable of connecting a keyboard to a computer system. A keyboard input adapter may be implemented as a PS/2 adapter, for example. Although a keyboard input adapter may be implemented as a PS/2 adapter, typical touch screen monitors connect to computers through a USB connection only. In such cases, therefore, it would be advantageous to implement the keyboard input adapter as a USB host controller (194), thereby limiting additional hardware that would be necessary in adding a PS/2 connection to the touch screen monitor.

A touch screen module (184) may send the converted keyboard keystroke in the native keyboard format to the keyboard input adapter of the computer system is by presenting a virtual USB keyboard to the USB host controller of the computer through the USB device of the touch screen monitor (180). The USB architecture provides a serial bus standard for connecting together devices (196) such as, for example, computers, game consoles, personal digital assistants, televisions, stereo equipment, and so on. The Universal Serial Bus Specification Revision 2.0 (‘USB Specification’) jointly authored by Compaq™, Hewlett-Packard™, Intel™, Lucent™, Microsoft™, NEC™, and Philips™ sets forth the standard for developing USB components and communicating among the components. USB components include, for example, devices, cables, hubs, hosts, ports, interfaces, mass storage devices, and so on. In USB terminology, the exemplary computer (152) containing the host controller (194) is referred to as a ‘host.’ The USB host controller (108) provides an interface for other components of the computer (152) to utilize USB hubs and USB devices connected to the USB host controller (194). The USB host controller (194) may be implemented as a combination of hardware, firmware, or software.

The USB architecture also provides for virtualization of USB devices in software. Such devices appear to the host computer to be actual hardware devices and enumerated in a manner identical to actual hardware devices. Hosts connected to such virtual devices also receive in a format identical to actual hardware devices. In the example of FIG. 1, for example, the touch screen module (184) may present to the USB host controller (194) of the computer (152) through the USB device (196) a virtual USB keyboard and send keyboard keystrokes to the computer (152) as USB usage codes for devices of the USB HID class.

From time to time a user may wish to remove the keyboard from the display of the touch screen monitor. The OSD module (186) therefore may also include computer program instructions for receiving a keyboard deactivation event; and responsive to the keyboard deactivation event and displaying only the graphics display image. That is, the keyboard deactivation event causes the OSD module to remove from the merged image the keyboard image (204), leaving only the graphics display image. Receiving a keyboard deactivation event may include receiving a keyboard deactivation event in response to an invocation of a dedicated hardware switch of the touch screen monitor or in the alternative receiving such an event through invocation of a GUI object as described above with respect to the keyboard activation event.

The touch screen module (184), OSD module (186), and keyboard image (204) of the exemplary touch screen monitor (180) of FIG. 1 are shown in RAM (168), but many components of such software typically are stored in non-volatile memory also, such as, for example, on a flash memory. In addition, the processor (156), RAM (168), bus adapter (158), I/O adapter (179), and other components of the touch screen monitor (180) are shown I FIG. 1 as separate components for clarity only. Readers of skill in the art will immediately recognize that such components may also be implemented in a single combination of the components such as, for example, in a microcontroller. Some components of the touch screen monitor (180) correspond to components in the computer (152). Readers of skill in the art will recognize that such components of the touch screen monitor operate in a manner similar to their corresponding component in the computer (152) described in detail below.

As mentioned above, the computer (152) of FIG. 1 also includes at least one computer processor (157) or ‘CPU’ as well as random access memory (169) (‘RAM’) which is connected through a high speed memory bus (151) and bus adapter (159) to the processor (156,157) and to other components. Stored in RAM (169) of the computer (152) is an application (198), a module of computer program instructions capable of causing the video adapter (210) of the computer (152) to transmit a graphics display image to the touch screen monitor (180). Application (198) may be, for example, a web browser, a word processor, or a spreadsheet application. Also stored in RAM (168) is an operating system (154). Operating systems useful emulating a keyboard on a touch screen monitor of a computer system according to embodiments of the present invention include UNIX™, Linux™, Microsoft XP™, AIX™, IBM's i5/OS™, and others as will occur to those of skill in the art. The operating system (154) and application (198) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (161) and bus adapter (159) to processor (157) and other components of the computer (152). Disk drive adapter (172) connects non-volatile data storage to the computer (152) in the form of disk drive (170). Disk drive adapters useful in computers for emulating a keyboard on a touch screen monitor of a computer system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. In many embodiments of the present invention however, the user input device in the computer system (105) is the input device provided by the touch screen monitor (180). The example computer (152) of FIG. 1 includes a video adapter (210), which is an example of an I/O adapter specially designed for graphic output to a display device such as a display screen or a touch screen monitor (180). Video adapter (210) is connected to processor (157) through a high speed video bus (164), bus adapter (159), and the front side bus (163), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for emulating a keyboard on a touch screen monitor of a computer system according to embodiments of the present invention include modems for wired dial-up communications, Ethernet (IEEE 802.3) adapters for wired data communications network communications, and 802.11 adapters for wireless data communications network communications.

The arrangement of the computer, input devices, touch screen monitor, and other devices making up the exemplary computer system (105) illustrated in FIG. 1 are for explanation, not for limitation. Computer systems useful according to various embodiments of the present invention may include additional components, servers, routers, and other devices, not shown in FIG. 1, as will occur to those of skill in the art. Networks connecting such computer systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

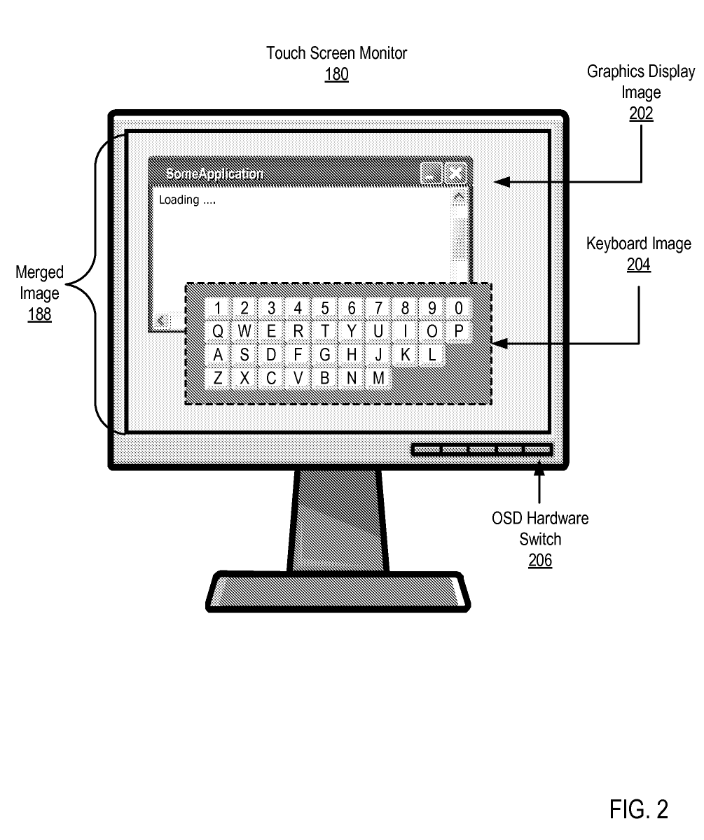

For further explanation, FIG. 2 sets forth a line drawing illustrating an exemplary touch screen monitor (180) of a computer system useful in emulating a keyboard according to embodiments of the present invention. The touch screen monitor (180) of FIG. 2 includes an on-screen display (‘OSD’) hardware switch (206). The OSD hardware switch of the exemplary touch screen monitor of FIG. 2 has been invoked by a user. Responsive to the invocation of the OSD hardware switch (206), the OSD module of the touch screen monitor (180), received a keyboard activation event and merged a keyboard image (204) with a graphics display image (202).

The exemplary merged image (188) of FIG. 2 includes a graphics display image (202). The graphics display image is an image received form a video adapter of a computer. In the example of FIG. 2 the graphics display image (202) portrays a graphical user interface (‘GUI’) of an application, the GUI including a title of “SomeApplication.” The GUI also includes text identifying the application as “Loading . . . ” From time to time applications, such as the application represented in the example of FIG. 2, running on a computer connected to a touch screen monitor of a computer system may malfunction and the computer may become erratic or non-responsive to input from the touch screen monitor. Such computer systems typically have no other input device attached and a user is typically unable to troubleshoot or remedy the current malfunction without attaching a hardware input device. The touch screen monitor of FIG. 2, however, enables a user to operate the keyboard displayed on the monitor as an actual hardware input device thereby removing the need to attach an actual hardware input device.

The exemplary merged image (188) of FIG. 2 also includes a keyboard image (204). The keyboard image (204) appears as an overlay on top of the graphics display image (202). The keyboard image represents a typical ‘QWERTY’ keyboard, including a row of numerals. Although the keyboard image in the example of FIG. 2 is depicted as a portion of QWERTY keyboard, readers of skill in the art will recognize that a keyboard image according to embodiments of the present invention may represent any type of keyboard having as many or as few keys as desired.

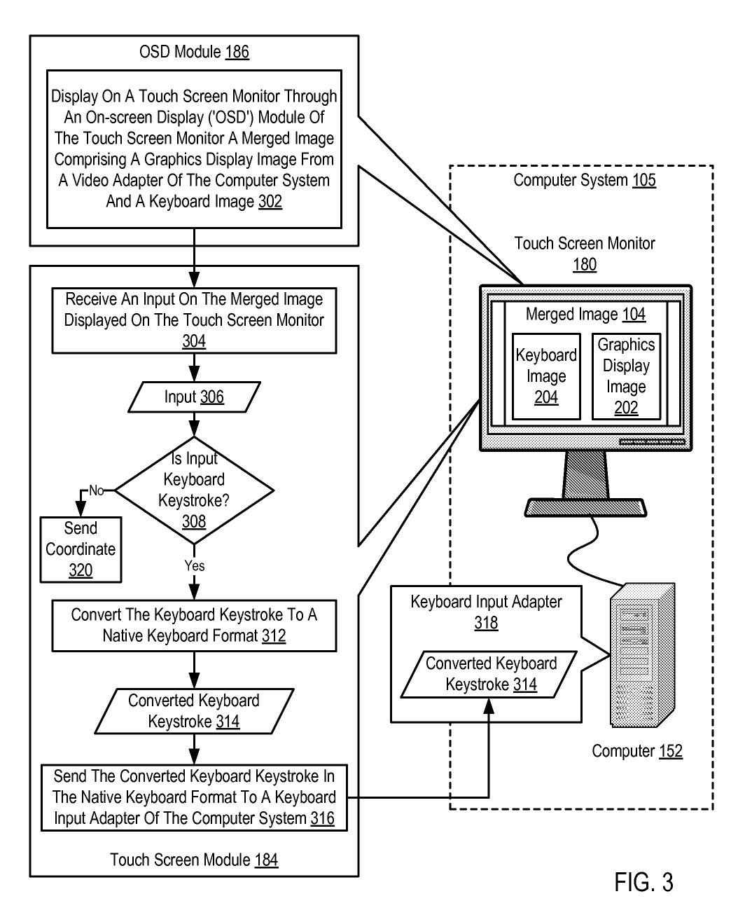

For further explanation, FIG. 3 sets forth a flow chart illustrating an exemplary method for emulating a keyboard on a touch screen monitor (180) of a computer system (105) according to embodiments of the present invention. The method of FIG. 3 includes displaying (302) on the touch screen monitor (180) through an on-screen display (‘OSD’) module (186) of the touch screen monitor (180) a merged image (104) comprising a graphics display image (202) from a video adapter of the computer system (105) and a keyboard image (204). Displaying (302) a merged image (104) may be carried out by multiplexing the keyboard image and the graphics display image and displaying the multiplexed image on a display panel of the touch screen monitor through a display driver.

The method of FIG. 3 also includes receiving (304), by a touch screen module (184), an input (306) on the merged image (104) displayed on the touch screen monitor (180). Receiving (304) an input (306) on the merged image (104) displayed on the touch screen monitor (180) may be carried out by receiving such an input from an touch screen overlay through a touch screen interface upon a user touching the overlay. As mentioned above such an overlay may be implemented with various technologies including resistive technology, Surface Acoustic Wave (‘SAW’) technology, capacitive technology, Infrared (‘IR’) technology, strain gauge technology, optical imaging technology, dispersive signal technology, acoustic pulse recognition technology, frustrated total internal reflection technology, and other technologies as will occur to those of skill in the art.

The method of FIG. 3 also includes determining (308), by the touch screen module (184), whether the input (306) is a keyboard keystroke. The touch screen module may identify the input as a keyboard keystroke by determining a coordinate for the input and determining that the coordinate is associated with a key on the image of the keyboard. The touch screen module may determine that the coordinate of the input is associated with a key on the image of the keyboard by comparing the coordinate of the input with a table associating keys on the keyboard with coordinates and finding in the table a matching coordinate.

If the input is a keyboard keystroke, the method of FIG. 3 continues by converting (312), by the touch screen module (180), the input (306) to a keyboard keystroke in a native keyboard format. Converting (312) the input (306) to a keyboard keystroke in a native keyboard format (314) may be carried out by identifying, in a table associating coordinates and keyboard keystrokes in native keyboard formats, a keyboard keystroke in a native keyboard format associated with the coordinate of the input. If the input is not a keyboard keystroke, the method of FIG. 3 continues by sending (320) the coordinate of the input to the computer for typical processing.

The method of FIG. 3 also includes sending (316), by the touch screen module (184), the converted keyboard keystroke (314) in the native keyboard format to a keyboard input adapter (318) of the computer system (105). Sending the keystroke to the keyboard input adapter of the computer system may be carried out in various ways in dependence upon the implementation of the keyboard input adapter. The touch screen module, for example, may send (316) the converted keyboard keystroke (314) to a keyboard input adapter of the computer system (105) by transmitting the keystroke as a USB usage code over a USB connection to a keyboard input adapter implemented as USB host controller, transmitting the keystroke as a PS/2 scan code over a PS/2 connection to a keyboard input adapter implemented as PS/2 adapter, or in other ways as will occur to those of skill in the art.

Exemplary embodiments of the present invention are described largely in the context of a fully functional computer system for emulating a keyboard on a touch screen monitor of a computer system. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of emulating a keyboard on a touch screen monitor of a computer system, the method comprising:
displaying on the touch screen monitor through an on-screen display (‘OSD’) module of the touch screen monitor a merged image comprising a graphics display image from a video adapter of the computer system and a keyboard image;
receiving, by a touch screen module, an input on the merged image displayed on the touch screen monitor;
determining, by the touch screen module, whether the input is a keyboard keystroke;
if the input is a keyboard keystroke:
converting, by the touch screen module, the input to a keyboard keystroke in a native keyboard format; and
sending, by the touch screen module, the converted keyboard keystroke in the native keyboard format to a keyboard input adapter of the computer system.

2. The method of claim 1 wherein the keyboard input adapter is a USB host controller.

3. The method of claim 1 further comprising:
receiving, by the OSD module of the touch screen monitor, a keyboard activation event; and
responsive to the keyboard activation event, merging the graphics display image from the video adapter of the computer system and a keyboard image.

4. The method of claim 3 wherein receiving, by the OSD module of the touch screen monitor, a keyboard activation event further comprises:
receiving a keyboard activation event in response to an invocation of a dedicated hardware switch of the touch screen monitor.

5. The method of claim 1 further comprising:
receiving, by the OSD module of the touch screen monitor, a keyboard deactivation activation event; and
responsive to the keyboard deactivation event, displaying only the graphics display image.

6. The method of claim 5 wherein receiving, by the OSD module of the touch screen monitor, a keyboard deactivation activation event further comprises:
receiving a keyboard deactivation event in response to an invocation of a dedicated hardware switch of the touch screen monitor.

7. An apparatus for emulating a keyboard on a touch screen monitor of a computer system, the apparatus comprising a computer processor, a computer memory operatively coupled to the computer processor, the computer memory having disposed within it computer program instructions capable of:
displaying on the touch screen monitor through an on-screen display (‘OSD’) module of the touch screen monitor a merged image comprising a graphics display image from a video adapter of the computer system and a keyboard image;
receiving, by a touch screen module, an input on the merged image displayed on the touch screen monitor;
determining, by the touch screen module, whether the input is a keyboard keystroke;
if the input is a keyboard keystroke:
converting, by the touch screen module, the input to a keyboard keystroke in a native keyboard format; and
sending, by the touch screen module, the converted keyboard keystroke in the native keyboard format to a keyboard input adapter of the computer system.

8. The apparatus of claim 7 wherein the keyboard input adapter is a USB host controller.

9. The apparatus of claim 7 further comprising computer program instructions capable of:
receiving, by the OSD module of the touch screen monitor, a keyboard activation event; and
responsive to the keyboard activation event, merging the graphics display image from the video adapter of the computer system and a keyboard image.

10. The apparatus of claim 9 wherein receiving, by the OSD module of the touch screen monitor, a keyboard activation event further comprises:
receiving a keyboard activation event in response to an invocation of a dedicated hardware switch of the touch screen monitor.

11. The apparatus of claim 7 further comprising computer program instructions capable of:
receiving, by the OSD module of the touch screen monitor, a keyboard deactivation activation event; and
responsive to the keyboard deactivation event, displaying only the graphics display image.

12. The apparatus of claim 11 wherein receiving, by the OSD module of the touch screen monitor, a keyboard deactivation activation event further comprises:
receiving a keyboard deactivation event in response to an invocation of a dedicated hardware switch of the touch screen monitor.

13. A computer program product for emulating a keyboard on a touch screen monitor of a computer system, the computer program product disposed in a computer readable medium, the computer program product comprising computer program instructions capable of:
displaying on the touch screen monitor through an on-screen display (‘OSD’) module of the touch screen monitor a merged image comprising a graphics display image from a video adapter of the computer system and a keyboard image;
receiving, by a touch screen module, an input on the merged image displayed on the touch screen monitor;
determining, by the touch screen module, whether the input is a keyboard keystroke;
if the input is a keyboard keystroke:
converting, by the touch screen module, the input to a keyboard keystroke in a native keyboard format; and
sending, by the touch screen module, the converted keyboard keystroke in the native keyboard format to a keyboard input adapter of the computer system.

14. The computer program product of claim 13 wherein the keyboard input adapter is a USB host controller.

15. The computer program product of claim 13 further comprising computer program instructions capable of:
receiving, by the OSD module of the touch screen monitor, a keyboard activation event; and
responsive to the keyboard activation event, merging the graphics display image from the video adapter of the computer system and a keyboard image.

16. The computer program product of claim 15 wherein receiving, by the OSD module of the touch screen monitor, a keyboard activation event further comprises:
receiving a keyboard activation event in response to an invocation of a dedicated hardware switch of the touch screen monitor.

17. The computer program product of claim 13 further comprising computer program instructions capable of:
receiving, by the OSD module of the touch screen monitor, a keyboard deactivation activation event; and
responsive to the keyboard deactivation event, displaying only the graphics display image.

18. The computer program product of claim 17 wherein receiving, by the OSD module of the touch screen monitor, a keyboard deactivation activation event further comprises:
receiving a keyboard deactivation event in response to an invocation of a dedicated hardware switch of the touch screen monitor.

19. The computer program product of claim 13 wherein the computer readable medium comprises a recordable medium.

20. The computer program product of claim 13 wherein the computer readable medium comprises a transmission medium.
